(19) United States
(12) Patent Application Publication
(10) Pub. No.: US 2026/0235830 A1
(43) Pub. Date: Aug. 13, 2026

(54) OPTICAL COUPLERS FOR PARTIAL INTERPOSER PACKAGE ARCHITECTURES

(71) Applicant: Lightmatter, Inc., Mountain View, CA (US)

(72) Inventors: Omkar Karhade, Chandler, AZ (US); Stefan Pfnuer, Scotts Valley, CA (US); Shashank Gupta, Gurugram (IN); Sufi Ahmed, Chandler, AZ (US); Sandeep Sane, Chandler, AZ (US)

(73) Assignee: Lightmatter, Inc., Mountain View, CA (US)

(21) Appl. No.: 19/532,642

(22) Filed: Feb. 6, 2026

Related U.S. Application Data
(60) Provisional application No. 63/756,005, filed on Feb. 7, 2025.
(60) Provisional application No. 63/762,736, filed on Feb. 25, 2025.
(60) Provisional application No. 63/766,294, filed on Mar. 3, 2025.
(60) Provisional application No. 63/780,130, filed on Mar. 28, 2025.
(60) Provisional application No. 63/925,412, filed on Nov. 25, 2025.

(51) Int. Cl. G02B 6/42

(52) U.S. Cl. CPC G02B 6/4292; G02B 6/4212; G02B 6/4214

(57) ABSTRACT

A photonic device includes a package comprising a partial interposer and an electronic-photonic assembly disposed thereon. The assembly comprises a photonic integrated circuit (PIC) having first and second sides, wherein the first side is attached to the partial interposer, and wherein the PIC comprises a waveguide defining a waveguide plane. The assembly further comprises an electronic integrated circuit (EIC) attached to the second side of the PIC and an encapsulant at least partially surrounding the EIC. The device includes an optical coupler attached to the PIC, configured to collimate light emitted by the PIC in a direction angled relative to the waveguide plane. The device includes an optical assembly comprising a detachable plug and fiber, positioned to receive the collimated light from the optical coupler.

### CROSS-REFERENCE TO RELATED APPLICATIONS

This application claims the benefit of U.S. Provisional Application Ser. No. 63/756,005, filed on Feb. 7, 2025, under Attorney Docket No. L0858.70112US01 and entitled “OPTICAL COUPLERS FOR OPTICAL DEVICES;” U.S. Provisional Application Ser. No. 63/762,736, filed on Feb. 25, 2025, under Attorney Docket No. L0858.70112US02 and entitled “MOLDED COLLIMATED LENS ARCHITECTURE FOR 3D OPTICAL PACKAGES;” U.S. Provisional Application Ser. No. 63/766,294, filed on Mar. 3, 2025, under Attorney Docket No. L0858.70112US03 and entitled “EXPOSED COUPLER MOLDED ARCHITECTURE FOR OPTICAL DEVICES;” U.S. Provisional Application Ser. No. 63/780,130, filed on Mar. 28, 2025, under Attorney Docket No. L0858.70112US04 and entitled “EXPOSED COUPLER MOLDED ARCHITECTURE FOR OPTICAL DEVICES;” and U.S. Provisional Application Ser. No. 63/925,412, filed on Nov. 25, 2025, under Attorney Docket No. L0858.70112US05 and entitled “EXPOSED COUPLER MOLDED ARCHITECTURE FOR OPTICAL DEVICES,” each of which is hereby incorporated herein by reference in its entirety.

### BACKGROUND

As data communications systems continue to scale to meet ever-increasing bandwidth demands, the limitations of traditional copper data channels have become increasingly apparent. Signal attenuation, crosstalk, and electromagnetic interference pose significant challenges, which can be partially mitigated through techniques such as equalization, coding, and shielding. However, these approaches often require substantial power, complexity, and cable bulk, offering only modest improvements in reach and limited scalability. Optical communication has emerged as a promising successor to copper links, offering the potential to overcome these limitations.

### SUMMARY

In some aspects, the techniques described herein relate to a photonic device, comprising: a package comprising a partial interposer and an electronic-photonic assembly disposed on the partial interposer, the electronic-photonic assembly comprising: a photonic integrated circuit (PIC) having a first side and a second side opposite the first side, wherein the first side of the PIC is attached to the partial interposer, and wherein the PIC comprises a waveguide defining a waveguide plane; an electronic integrated circuit (EIC) attached to the second side of the PIC; and an encapsulant at least partially surrounding the EIC; an optical coupler attached to the PIC, wherein the optical coupler is configured to collimate, in a first direction that is angled relative to the waveguide plane, light emitted by the PIC upon being guided by the waveguide; and an optical assembly comprising a detachable plug and a fiber attached to the detachable plug, wherein the optical assembly is positioned to receive the collimated light from the optical coupler.

In some aspects, the techniques described herein relate to a photonic device, wherein the package is configured as a chip-on-wafer-on-substrate (CoWoS) package in which the partial interposer serves as a bridge between the electronic-photonic assembly and at least one other component of the package.

In some aspects, the techniques described herein relate to a photonic device, wherein the optical assembly is disposed on a top surface of the encapsulant.

In some aspects, the techniques described herein relate to a photonic device, wherein the optical coupler comprises: a reflective portion configured to reflect the light emitted by the PIC in the first direction; and a convex portion configured to perform the collimation.

In some aspects, the techniques described herein relate to a photonic device, wherein the PIC defines a recess near an end of the waveguide, and wherein the reflective portion extends into the recess.

In some aspects, the techniques described herein relate to a photonic device, further comprising an index-matching epoxy disposed in the recess.

In some aspects, the techniques described herein relate to a photonic device, wherein the optical coupler extends through the encapsulant.

In some aspects, the techniques described herein relate to a photonic device, wherein the detachable plug comprises a fiber array unit (FAU) configured to hold the fiber with a predefined pitch.

In some aspects, the techniques described herein relate to a photonic device, further comprising a second EIC and a third EIC disposed on the partial interposer, wherein the partial interposer places the electronic-photonic assembly in electrical communication with the second EIC but not the third EIC.

In some aspects, the techniques described herein relate to a photonic device, wherein the second EIC comprises a processing chip, and the third EIC comprises a high-bandwidth memory.

In some aspects, the techniques described herein relate to a photonic device, comprising: a package comprising a partial interposer and an electronic-photonic assembly disposed on the partial interposer, the electronic-photonic assembly comprising: a photonic integrated circuit (PIC) comprising a waveguide extending near a sidewall of the PIC; an electronic integrated circuit (EIC) attached to the PIC; and an encapsulant at least partially encapsulating the EIC; an optical assembly comprising a detachable plug and a fiber attached to the detachable plug; and an optical coupler between the sidewall of the PIC and the optical assembly, wherein the optical coupler is configured to couple light received from the waveguide to the fiber.

In some aspects, the techniques described herein relate to a photonic device, wherein the package is configured as a chip-on-wafer-on-substrate (CoWoS) package in which the partial interposer serves as a bridge between the electronic-photonic assembly and at least one other component of the package.

In some aspects, the techniques described herein relate to a photonic device, wherein the optical coupler comprises: a first reflective portion configured to reflect the light received from the waveguide in a first direction that is angled relative to a plane defined by the waveguide; and a second reflective portion configured to reflect the light reflected by the first reflective portion in a second direction that is parallel to the plane defined by the waveguide.

In some aspects, the techniques described herein relate to a photonic device, wherein the optical coupler is made of silicon.

In some aspects, the techniques described herein relate to a photonic device, wherein the PIC defines a recess near an edge of the PIC, and wherein the optical coupler is disposed in the recess.

In some aspects, the techniques described herein relate to a photonic device, wherein the optical coupler extends through the encapsulant.

In some aspects, the techniques described herein relate to a photonic device, wherein the optical coupler comprises a collimator configured to collimate the light received from the waveguide.

In some aspects, the techniques described herein relate to a photonic device, wherein the collimator comprises a convex surface.

In some aspects, the techniques described herein relate to a photonic device, further comprising a second EIC and a third EIC disposed on the partial interposer, wherein the partial interposer places the electronic-photonic assembly in electrical communication with the second EIC but not the third EIC.

In some aspects, the techniques described herein relate to a photonic device, wherein the second EIC comprises a processing chip, and the third EIC comprises a high-bandwidth memory.

### BRIEF DESCRIPTION OF FIGURES

Various aspects and embodiments of the application will be described with reference to the following figures. It should be appreciated that the figures are not necessarily drawn to scale. Items appearing in multiple figures are indicated by the same reference number in the figures in which they appear.

FIG. 1A is a side view of a photonic device including an electronic-photonic assembly, a top optical coupler and a detachable plug holding an optical fiber, according to aspects of the present disclosure.

FIG. 1B is a side view of a portion of the photonic device of FIG. 1A, according to aspects of the present disclosure.

FIG. 2A is a side view of a package including an electronic-photonic assembly disposed on a partial interposer, according to aspects of the present disclosure.

FIG. 2B is a side view illustrating a potential implementation of the optical coupler of FIG. 2A, according to aspects of the present disclosure.

FIG. 2C is a side view illustrating the optical coupler of FIG. 2B in additional detail, according to aspects of the present disclosure.

FIG. 2D is a side view illustrating an alternative implementation of the optical coupler, according to aspects of the present disclosure.

FIG. 2E is a side view of a package including an electronic-photonic assembly disposed on an interposer configured as a bridge, wherein a controller extends partially beyond an edge of a PIC, according to aspects of the present disclosure.

FIG. 3A is a side view of a package including an electronic-photonic assembly having a side optical coupler and a detachable plug holding an optical fiber, according to aspects of the present disclosure.

FIG. 3B is a side view of a package including an electronic-photonic assembly disposed on a partial interposer, according to aspects of the present disclosure.

FIG. 4A is a cross-sectional side view of a photonic device including an electronic-photonic assembly with an optical coupler configuration, according to aspects of the present disclosure.

FIG. 4B is a side view of an optical coupler assembly and a detachable plug holding an optical fiber, according to aspects of the present disclosure.

FIG. 5 is a side view of a package including an electronic-photonic assembly disposed on an interposer with an embedded multi-die interconnect bridge (EMIB), according to aspects of the present disclosure.

### DETAILED DESCRIPTION

### I. Overview

Partial interposers represent an emerging technology in advanced semiconductor packaging that provides an alternative approach to chip-to-chip interconnection. Partial interposers refer to interposer structures that serve as a bridge between selected components of a package rather than interconnecting all packaged chips and assemblies together. In contrast, a full interposer may be used to interconnect all the packaged chips and assemblies together within a single package. Both full and partial interposers include electrical interconnects formed within a substrate material. In partial interposers, the electrical interconnects occupy only a sub-portion of the substrate, providing localized high-density connections between specific adjacent components. In full interposers, the electrical interconnects extend across the entire surface of the substrate, enabling communication pathways among all chips and assemblies disposed on the interposer.

In some embodiments, a package may be implemented as a chip-on-wafer-on-substrate (CoWoS)-L package, in which partial interposers serve as bridges between selected chips or assemblies. The CoWoS-L architecture employs partial interposers that connect specific components while other components may be interconnected through alternative pathways. In some embodiments, a partial interposer in a CoWoS-L configuration may bridge an electronic-photonic assembly with a processing chip, while other components such as high-bandwidth memory may be connected through separate interconnection structures. In contrast to partial interposer approaches, a package may be implemented as a CoWoS-S package in which an interposer is used to interconnect all the packaged chips and assemblies together. In a CoWoS-S configuration, a single interposer may span the entire package and may provide interconnections among all chips and assemblies disposed on the interposer.

Another example of a partial interposer architecture includes embedded multi-die interconnect bridge (EMIB) configurations. An EMIB may be embedded within a substrate and may provide localized high-density interconnections between adjacent dies. The EMIB approach may allow for selective bridging between components without requiring a full interposer spanning the entire package area.

Partial interposers may offer advantages for electronic-photonic assemblies. In some embodiments, partial interposers may reduce manufacturing complexity, compared to full interposer approaches, because the partial interposer may have a smaller area and may require fewer interconnection layers. In some embodiments, partial interposers may improve yield because defects in one portion of the package may not affect the entire interposer structure. Partial interposers may also be suitable for integrating photonic interfaces with processing chips and high-bandwidth memory components, as the partial interposer may provide high-density interconnections between the electronic-photonic assembly and selected components while allowing flexibility in the overall package architecture.

Integrating photonic devices with partial interposer packaging technologies presents a challenge. Coupling light from the package to external fibers, and vice versa, is difficult. Advanced packages such as those implemented using partial interposer architectures employ mold encapsulation to stabilize and protect the chip-on-wafer assembly before the chip-on-wafer assembly is attached to a substrate. Partial interposers are often implemented as large, thin silicon slabs supporting multiple large chips. The chips are often positioned on the interposer in a way that creates a non-uniform weight distribution, which can cause mechanical stress to the interposer, resulting in warpage and cracking. To prevent these negative effects, advanced packages employ mold encapsulation.

An encapsulant may at least partially surround an electronic integrated circuit (EIC) within an electronic-photonic assembly. In some embodiments, the encapsulant may laterally surround the EIC on two, three, or four sides. The encapsulant may form a continuous perimeter around the EIC, while in other implementations the encapsulant may be discontinuous and may surround only some of the sides of the EIC. The encapsulant may be formed using overmolding techniques including transfer molding, compression molding, or a combination thereof. The encapsulant provides mechanical stability and warpage control, which is particularly desirable in devices in which a photonic integrated circuit (PIC) has been thinned. In some embodiments, the PIC may have a thickness between 50 μm and 100 μm after thinning. The weight of overlaying EICs may make thin PICs susceptible to warpage, which over time can mechanically damage the chip. The encapsulant reduces this effect.

Use of mold encapsulation, however, produces variability in the height of the package because underlying chips may have different heights. Variability in the height of the package translates into variability in the position of fibers along the vertical direction. This variability in fiber position produces an offset between the input plane of a fiber and the focal plane of a spot-size converter, resulting in poor coupling efficiency. The height of the encapsulant may be dictated by the vertical extension of the EIC, but in some embodiments the height of the encapsulant may be difficult to control with precision. The height of the encapsulant at the edge of the device may be slightly different from the height of the EICs due to spatial variability in the process for removing molding material in excess.

Optical coupling between a PIC and external fibers may be performed from the top of the package or from the side of the package. Each approach addresses different challenges associated with integrating photonic devices into partial interposer package architectures. In top optical coupling, light is directed from the PIC in a direction that is angled relative to the waveguide plane, typically toward the top surface of the package. A photonic device employing top optical coupling may include a package comprising a partial interposer and an electronic-photonic assembly disposed on the partial interposer. The electronic-photonic assembly may include a PIC having a first side attached to the partial interposer and a second side opposite the first side. The PIC may include a waveguide defining a waveguide plane. An EIC may be attached to the second side of the PIC, and an encapsulant may at least partially surround the EIC. In some embodiments, the package may be configured as a CoWoS package in which the partial interposer serves as a bridge between the electronic-photonic assembly and at least one other component of the package.

Top optical couplers of the types described herein address the challenge of encapsulant height variability. To promote PIC-fiber coupling efficiency despite variability in the height of an encapsulant, a top optical coupler may be configured to provide optical collimation. Collimation refers to the effect by which a device takes divergent or convergent optical rays and makes them parallel. Collimators are devices that straighten optical beams. As used herein, the terms “collimator” and “collimation” should be interpreted broadly to include scenarios in which a beam's angle of divergence (or, in the opposite direction, the angle of convergence) is reduced. In other words, the output beam need not be perfectly parallel, but may be quasi-parallel. In one example, a collimator may take a beam having an angle of divergence of approximately 10 degrees and may output a beam having an angle of divergence of approximately 3 degrees. In another example, a collimator may take a beam having an angle of divergence of approximately 10 degrees and may output a beam having an angle of convergence of approximately 3 degrees. By employing collimators, a top coupler produces an optical beam having rays that are parallel or quasi-parallel to one another, making the coupling efficiency less susceptible to variations in the height of the package.

By contrast, side optical couplers of the types described herein can address at least one of two potential challenges. First, the encapsulant may block the side of the PIC that is configured to emit light, thereby preventing direct optical access to the PIC. To overcome this obstacle, a side optical coupler may be positioned between the sidewall of the PIC and an optical assembly that includes a detachable plug and a fiber attached to the detachable plug. The optical coupler may include a first reflective portion configured to reflect light received from the waveguide in a first direction that is angled relative to the waveguide plane, and a second reflective portion configured to reflect the light from the first reflective portion in a second direction that is parallel to the waveguide plane. Using this arrangement, the optical coupler forms an optical conduit that routes light around or through the encapsulant, providing optical access to the PIC without compromising the mechanical integrity of the package.

Second, side optical coupling can address the challenge of edge surface roughness caused by singulation. During fabrication, a semiconductor wafer is singulated into individual dies using dicing, scribing, laser cutting, or other separation techniques. These processes may produce edge surfaces with irregularities that can cause scattering, reflection, or mode distortion as light exits the PIC, resulting in optical attenuation. To mitigate this effect, the PIC may define a recess near an edge of the PIC, and the optical coupler may be disposed in the recess. The recess separates the sidewall from which light exits the PIC from the rough singulated edge of the PIC. By emitting light through the sidewall rather than through the singulated edge, the recess reduces the interaction between the optical signal and the rough edge surface, thereby preserving signal integrity.

### II. Top Couplers

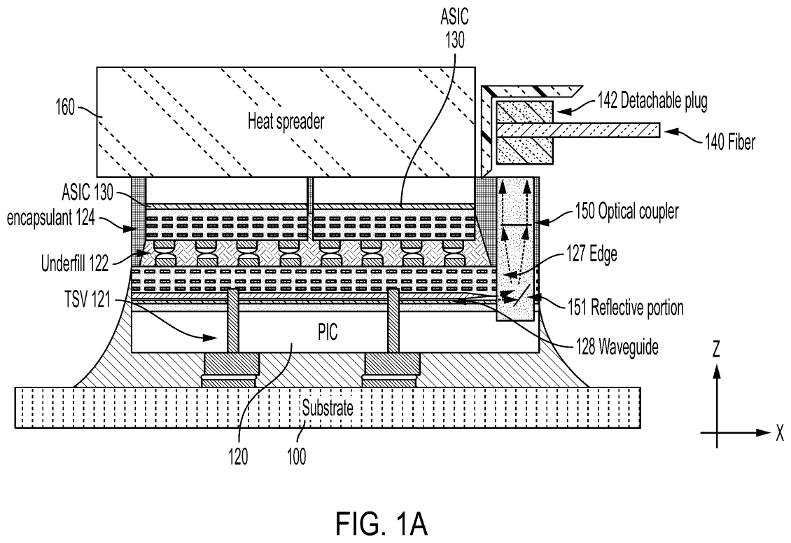

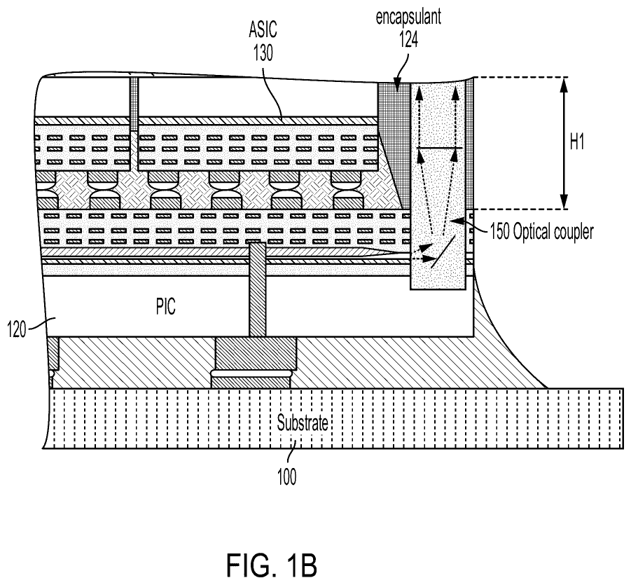

Referring to FIG. 1A, a photonic device includes an electronic-photonic assembly, a top optical coupler 150, and a detachable plug 142 holding an optical fiber 140. A substrate 100 is positioned at the bottom of the assembly. The substrate 100 may form part of an interposer configured to route signals generated inside the device to external devices and vice versa.

A photonic integrated circuit (PIC) 120 is disposed on the substrate 100. The PIC 120 may be active in nature and may include modulators, photodetectors, and/or optical switches. In some embodiments, the PIC 120 may be equipped with optical switches to route data to and from other devices. The PIC 120 includes a waveguide 128 that extends near an edge 127 of the PIC 120. The waveguide 128 defines a waveguide plane that is parallel to the xy plane of FIG. 1A. In some embodiments, the PIC 120 may be made of silicon and the waveguide 128 may be made of silicon or silicon nitride. The PIC 120 may further include a network of waveguides that route light inside the PIC 120 within the waveguide plane. A plurality of through-silicon vias (TSV) 121 are patterned within the PIC 120. The TSVs 121 place the electronic circuitry of the PIC 120 in electrical communication with the substrate 100.

One or more application-specific integrated circuits (ASIC) 130 are attached to the PIC 120. ASICs of the types described herein are also referred to as electronic integrated circuits (EICs). Each ASIC 130 may include input/output (I/O) circuitry, control circuitry, processing circuitry, and/or memory circuitry. I/O circuitry may include serializers/deserializers (SerDes).

Control circuitry may include electronic components configured to interface with active photonic circuitry within the PIC 120. In some embodiments, the control circuitry may include modulator drivers configured to drive optical modulators and trans-impedance amplifiers configured to detect photocurrents produced by photodetectors. In some embodiments, the control circuitry may further include analog-to-digital converters and digital-to-analog converters. Processing circuitry may be implemented as a central processing unit (CPU), a graphics processing unit (GPU), a field programmable gate array (FPGA), a tensor processing unit (TPU), or an accelerator. Memory circuitry may be implemented as a high-bandwidth memory (HBM). In some embodiments, only a portion of an ASIC 130 may be disposed on top of the PIC 120, with the remainder of the bottom surface of the ASIC 130 extending beyond the outer edge of the PIC 120.

An underfill 122 fills the space between the PIC 120 and the ASICs 130. The underfill 122 protects the bumps, pads, or other types of electrical features connecting the top surface of the PIC 120 to the bottom surfaces of the ASICs 130.

An encapsulant 124 at least partially surrounds the ASICs 130. In some embodiments, the encapsulant 124 may laterally surround a group of ASICs on two, three, or four sides. The encapsulant 124 may form a continuous perimeter around the ASICs 130, while in other implementations the encapsulant 124 may be discontinuous and may surround only some of the sides of the ASICs 130. The encapsulant 124 may be formed using overmolding techniques including transfer molding, compression molding, or a combination thereof. The encapsulant 124 provides mechanical stability and warpage control, which is particularly desirable in devices in which the PIC 120 has been thinned.

A heat spreader 160 is attached to the top surface of the ASICs 130. The heat spreader 160 facilitates distribution of heat generated within the package to the external environment. The heat spreader 160 covers the ASICs 130, protecting the package from external agents.

The optical coupler 150 is attached to the PIC 120 near the edge 127. The optical coupler 150 includes a reflective portion 151 configured to reflect light received from the waveguide 128 substantially towards a vertical direction. In some embodiments, the reflective portion 151 may be angled by approximately 45 degrees relative to the waveguide plane. The reflective portion 151 may be implemented as a conductive surface having a large reflection coefficient, or may be implemented to operate by total internal reflection. The optical coupler 150 extends through the encapsulant 124.

An optical assembly including the detachable plug 142 and the fiber 140 attached to the detachable plug 142 is disposed on a top surface of the encapsulant 124. The optical assembly is positioned to receive collimated light from the optical coupler 150. The detachable plug 142 may be configured to facilitate straightforward connection between the fiber 140 and the electronic-photonic assembly. This configuration enables optical fibers to be readily removed and replaced, for example in the event of fiber damage, without requiring disposal or replacement of the entire device.

In some embodiments, the detachable plug 142 may include a fiber array unit (FAU), a support configured to hold fibers with a predefined pitch. The FAU may include an array of V-grooves or U-grooves that have been etched on a support to hold fibers in place. The fiber 140 may be oriented along a plane substantially parallel to the xy plane in the region where the fiber 140 is attached to the detachable plug 142. In other arrangements, the fiber 140 may be oriented along a plane substantially parallel to the zy plane, or at a slight angle relative to the z-axis of less than 20 degrees.

In some embodiments, a bracket may allow the detachable plug 142 to be mechanically secured to the package and easily removed from the package. In some embodiments, a set of brackets may facilitate attachment of the detachable plug 142 to the package.

To convert the parallel or quasi-parallel beam provided by the optical coupler 150 into a beam having a size compatible with the numerical aperture of the fiber 140, the detachable plug 142 may be equipped with a spot-size converter. In some embodiments, the detachable plug 142 may be equipped with a reflective portion configured to reflect light received from the reflective portion 151 towards a direction parallel to the xy plane. In some embodiments, the detachable plug 142 may include a lens configured to focus light received from the reflective portion on the input plane of the fiber 140.

Referring to FIG. 1B, a side view of a portion of the photonic device of FIG. 1A illustrates the structural arrangement of components within the electronic-photonic assembly. The height H1 of the encapsulant 124 in the vertical direction may be dictated by the vertical extension of the ASIC 130. In some embodiments, it may be difficult to precisely control the height of the encapsulant 124. The height H1 may be slightly different from a nominal value due to spatial variability in the process for removing molding material in excess. As a result, the height H1 may be slightly different from the height of the ASIC 130. Due to variability in the height of the encapsulant 124, the position of the detachable plug along the vertical axis may also be subject to variations, resulting in a reduction of PIC-fiber coupling efficiency.

The optical coupler 150 is attached to the PIC 120 near an edge of the device. The optical coupler 150 extends through the encapsulant 124. To address the variability in the height of the encapsulant 124, the optical coupler 150 may be configured to provide optical collimation, making the coupling efficiency less susceptible to variations in the height of the package. Examples of optical collimators are described in detail further below.

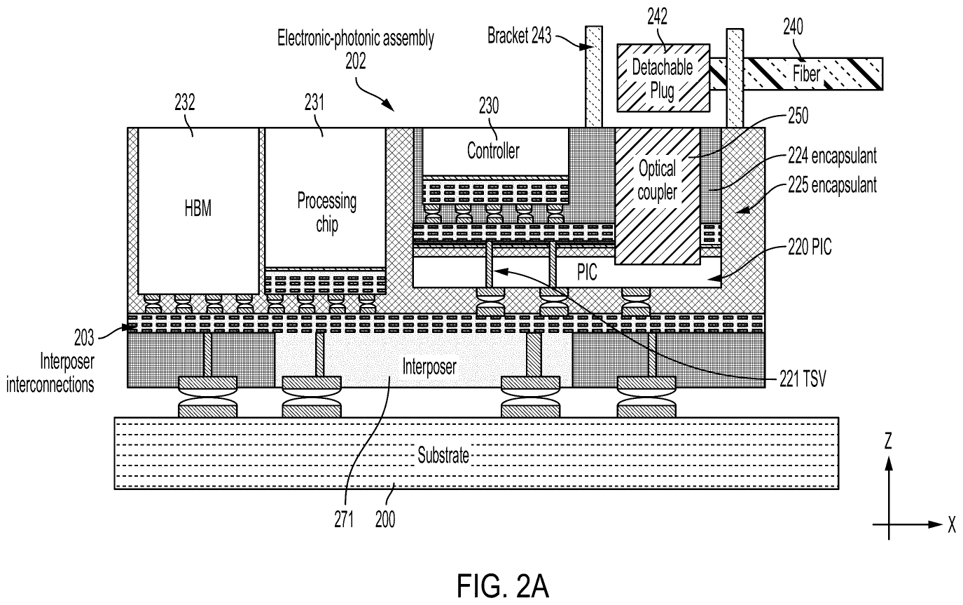

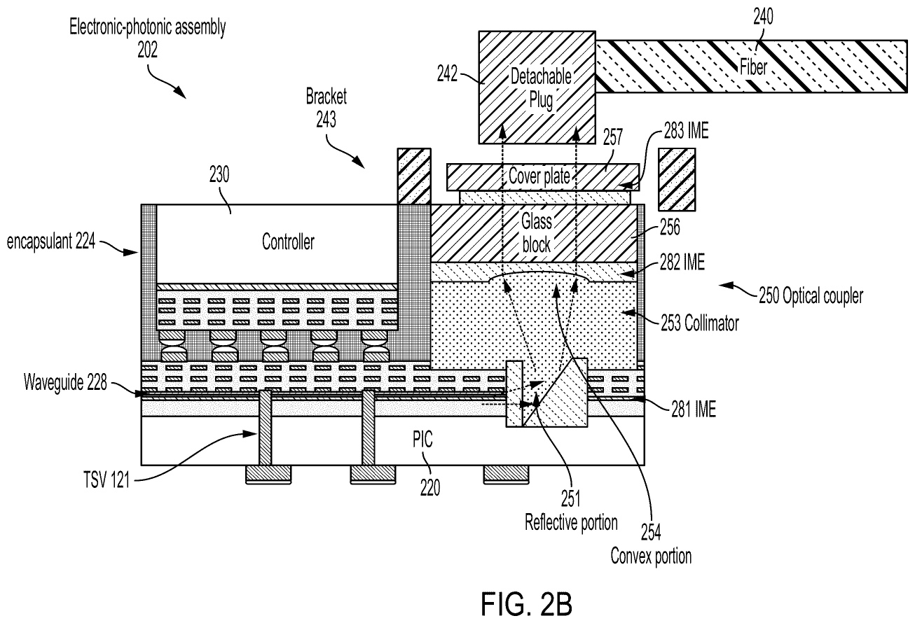

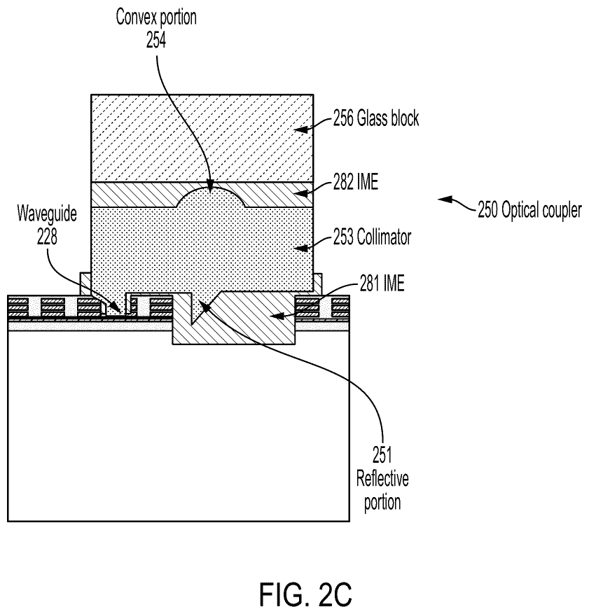

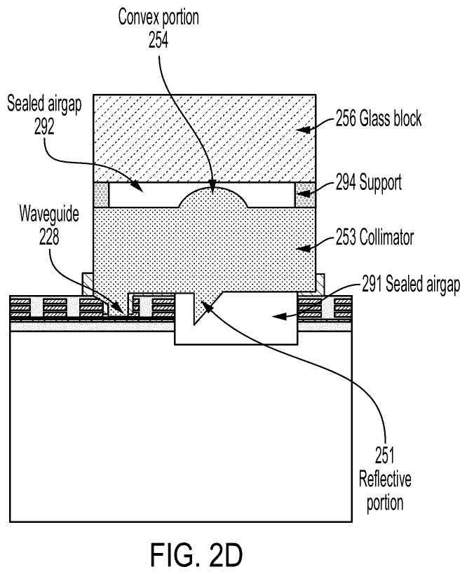

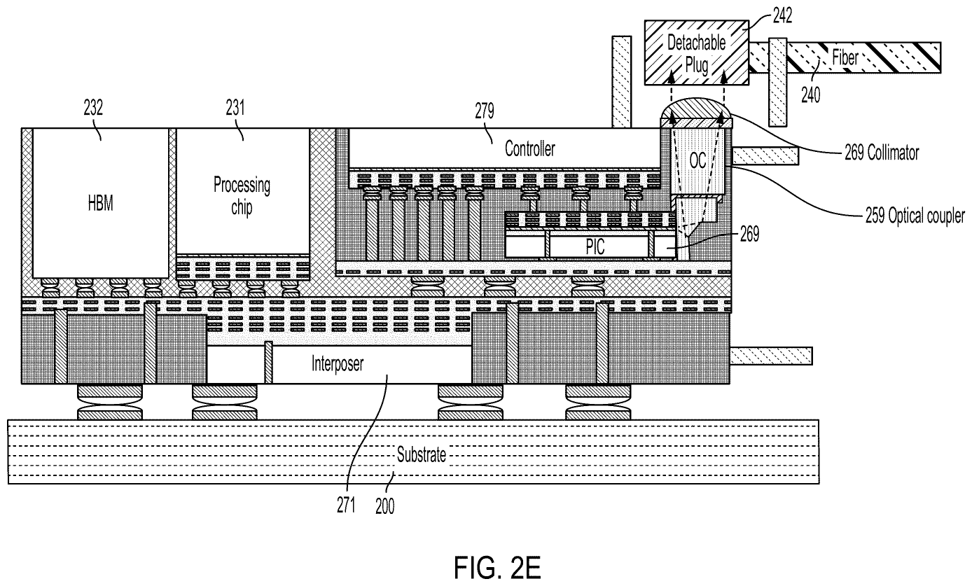

Referring to FIG. 2A, a package includes an electronic-photonic assembly 202 disposed on an interposer 271. Electronic-photonic assembly 202 may be implemented using the ASIC-PIC stack described with reference to FIGS. 1A-1B. The package may be implemented as a CoWoS-L configuration in which the interposer 271 serves as a bridge between selected components rather than interconnecting all packaged chips and assemblies together. A substrate 200 is positioned at the bottom of the package. The interposer 271 is attached to the substrate 200.

The interposer 271 includes interposer interconnections 203 configured to place chips and assemblies in communication with each other. A processing chip 231 is disposed on the interposer 271. The processing chip 231 may be implemented as a central processing unit (CPU), a graphics processing unit (GPU), a tensor processing unit (TPU), or a field programmable gate array (FPGA). A high-bandwidth memory 232 is also disposed on the interposer 271. The partial interposer 271 places the electronic-photonic assembly 202 in electrical communication with the processing chip 231.

The electronic-photonic assembly 202 serves as an optical interface, placing the chips of the package in optical communication with external devices via optical fibers. The electronic-photonic assembly 202 includes a PIC 220 having a first side and a second side opposite the first side. The first side of the PIC 220 is attached to the interposer 271. The PIC 220 includes through-silicon vias (TSV) 221 that provide electrical communication between the electronic circuitry of the PIC 220 and the interposer 271.

A controller 230 is attached to the second side of the PIC 220. The controller 230 may include electronic circuitry configured to interface with active photonic circuitry within the PIC 220. In some embodiments, the controller 230 may include modulator drivers configured to drive optical modulators and trans-impedance amplifiers configured to detect photocurrents produced by photodetectors. In some embodiments, the controller 230 may include serializers/deserializers (SerDes). Controller 230 may be arranged in the same configuration described with reference to ASIC 130.

An encapsulant 224 at least partially surrounds the controller 230 within the electronic-photonic assembly 202. The encapsulant 224 may laterally surround the controller 230 on two, three, or four sides.

As further shown in FIG. 2A, an optical coupler 250 is attached to the PIC 220. The optical coupler 250 extends through the encapsulant 224. The optical coupler 250 is configured to collimate light emitted by the PIC 220 in a direction that is angled relative to a waveguide plane defined within the PIC 220 (e.g., along the z-axis or at a slight angle relative to the z-axis). An optical assembly including a detachable plug 242 and a fiber 240 attached to the detachable plug 242 is positioned to receive collimated light from the optical coupler 250. A bracket 243 allows the detachable plug 242 to be mechanically secured to the package and easily removed from the package. A second encapsulant 225 at least partially surrounds the electronic-photonic assembly 202. In some embodiments, the encapsulant 225 may laterally surround the electronic-photonic assembly 202 on two, three, or four sides. The encapsulant 225 may form a continuous perimeter around the electronic-photonic assembly 202, while in other implementations the encapsulant 225 may be discontinuous and may surround only some of the sides of the electronic-photonic assembly 202. The encapsulant 225 may be formed using overmolding techniques including transfer molding, compression molding, or a combination thereof. While the encapsulant 224 provides mechanical stability within the electronic-photonic assembly 202, the encapsulant 225 provides mechanical stability and warpage control at the package level. The height of the encapsulant 225 at the edge of the package may be slightly different from a nominal value, leading to variability in the vertical position of the detachable plug 242. To address this variability, the optical coupler 250 may be equipped with a collimator.

Referring to FIG. 2B, a side view illustrates a potential implementation of the optical coupler 250 of FIG. 2A. The optical coupler includes a collimator 253 having a reflective portion 251 and a convex portion 254. The reflective portion 251 and the convex portion 254 are positioned on opposite sides of the collimator 253. The reflective portion 251 is located on a lower side of the collimator 253, near an end of the waveguide 228. The reflective portion 251 is configured to reflect light emitted by the PIC 220 in a direction that is angled relative to the waveguide plane. In some embodiments, the reflective portion 251 may define a surface angled by approximately 45 degrees relative to the waveguide plane to reflect light substantially towards a vertical direction. The reflective portion 251 may be implemented as a conductive surface having a large reflection coefficient, or may be implemented to operate by total internal reflection.

The convex portion 254 is configured to perform collimation of the reflected light. The convex portion 254 is positioned at an upper surface of the collimator 253. The convex portion 254 defines a curved surface having a curvature designed to collimate the beam reflected by the reflective portion 251, thereby producing parallel or quasi-parallel rays.

A glass block 256 is disposed on top of the collimator 253. The glass block 256 facilitates coupling of the collimated beam into the fiber 240. A cover plate 257 is disposed on top of the glass block 256.

Referring now to FIG. 2C, index-matching epoxy (IME) layers are positioned at various interfaces to minimize back-reflections. An IME 281 is disposed in a recess near the end of the waveguide 228. The PIC 220 may define the recess near the end of the waveguide 228, and the reflective portion 251 may extend into the recess. The IME 281 fills the remaining volume of the recess to facilitate optical coupling between an edge of the PIC 220 and the collimator 253 while minimizing backreflections. An IME 282 is disposed between the collimator 253 and the glass block 256 to minimize back-reflections at that interface. An IME 283 is disposed between the glass block 256 and the cover plate 257 to further minimize back-reflections.

Referring to FIG. 2D, a side view illustrates an alternative implementation of the optical coupler. This implementation is similar to the implementation shown in FIG. 2C in that the implementation of FIG. 2D also includes the collimator 253 positioned between the waveguide 228 and the glass block 256. In this implementation, however, index-matching epoxies are omitted. Instead, the optical coupler defines a sealed airgap 291 between the waveguide 228 and the reflective portion 251, and a sealed airgap 292 between the convex portion 254 and the glass block 256. The sealed airgap 291 and the sealed airgap 292 provide an alternative approach to managing optical interfaces within the coupler structure.

Referring to FIG. 2E, a package includes an electronic-photonic assembly disposed on the interposer 271, where the interposer 271 is configured as a bridge in a CoWoS-L package configuration. In this arrangement, the interposer 271 serves as a bridge between selected components rather than interconnecting all packaged chips and assemblies together. The package of FIG. 2E differs from the package of FIG. 2A in several respects, including the positioning of the controller relative to the PIC and the arrangement of optical coupling components.

First, in the arrangement of FIG. 2E, the controller 279 is partially disposed outside an edge of the PIC. A portion of the controller 279 extends beyond the outer edge of the PIC and is partially connected to the interposer 271 via pillars. This arrangement differs from the arrangement of FIG. 2A, in which the controller 230 is disposed entirely on top of the PIC 220. Additionally, the arrangement of FIG. 2E includes a collimator 269 that is defined as a distinct component relative to the coupler 259. The collimator 269, which is configured to collimate light emitted by the PIC, is disposed on top of the optical coupler 259. The collimator 269 may be implemented as a glass element having a flat lower surface and a curved upper surface.

In some embodiments, a package may include one of the features described in connection with FIG. 2E, such as the controller partially disposed outside the edge of the PIC, or the collimator positioned on top of the optical coupler. In some embodiments, a package may include both of these features. The collimator 269 may also be used in the package of FIG. 2A as an alternative to the integrated collimator 253 arrangement shown in FIG. 2B.

### III. Side Couplers

Side optical couplers of the types described herein address challenges associated with integrating photonic devices into partial interposer package architectures. In some embodiments, a side optical coupler receives light emitted from a sidewall of the PIC, redirects the light vertically using a first reflective portion, and then redirects the light horizontally toward an external fiber using a second reflective portion.

Side optical couplers overcome two distinct challenges in photonic packaging. The first challenge involves the encapsulant obstructing the light-emitting side of the PIC, which would otherwise prevent direct optical coupling. A side optical coupler addresses this by being positioned between the PIC sidewall and an optical assembly comprising a detachable plug with an attached fiber. The coupler incorporates a first reflective surface that redirects light from the waveguide at an angle relative to the waveguide plane, and a second reflective surface that further redirects this light into a direction parallel to the waveguide plane. This configuration enables the optical coupler to serve as an optical pathway that guides light around or through the encapsulant material, thereby enabling optical access to the PIC while maintaining the structural integrity of the package.

The second challenge that side optical coupling addresses relates to surface roughness at die edges resulting from singulation processes. When semiconductor wafers are separated into individual dies through dicing, scribing, laser cutting, or similar techniques, the resulting edge surfaces often exhibit roughness that can induce scattering, unwanted reflections, or mode distortion when light passes through, leading to signal attenuation. To address this issue, a recess may be formed in the PIC near its edge, with the optical coupler positioned within this recess. This recess creates separation between the light-emitting sidewall of the PIC and the roughened singulated edge. Because light exits the PIC through the sidewall instead of the singulated edge, interaction between the optical signal and the irregular edge surface is minimized, thereby maintaining signal quality.

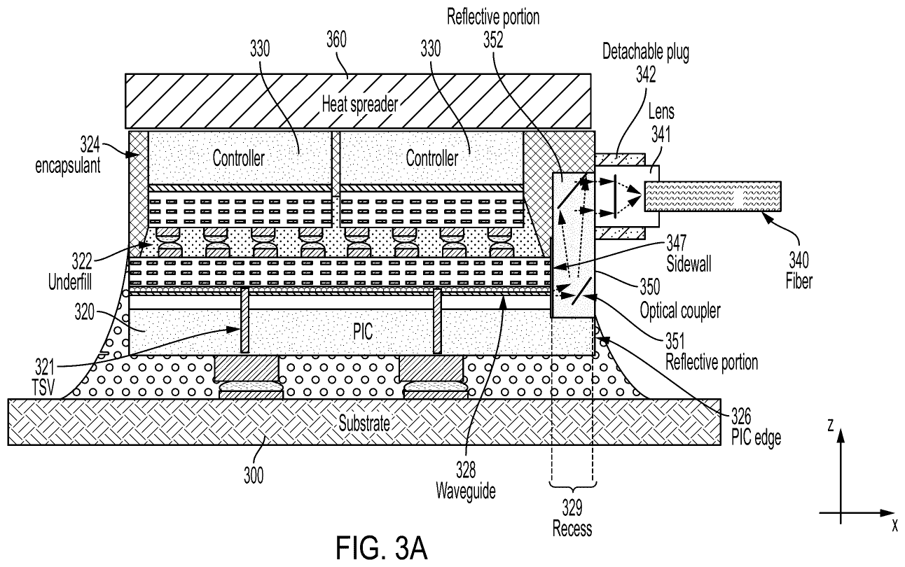

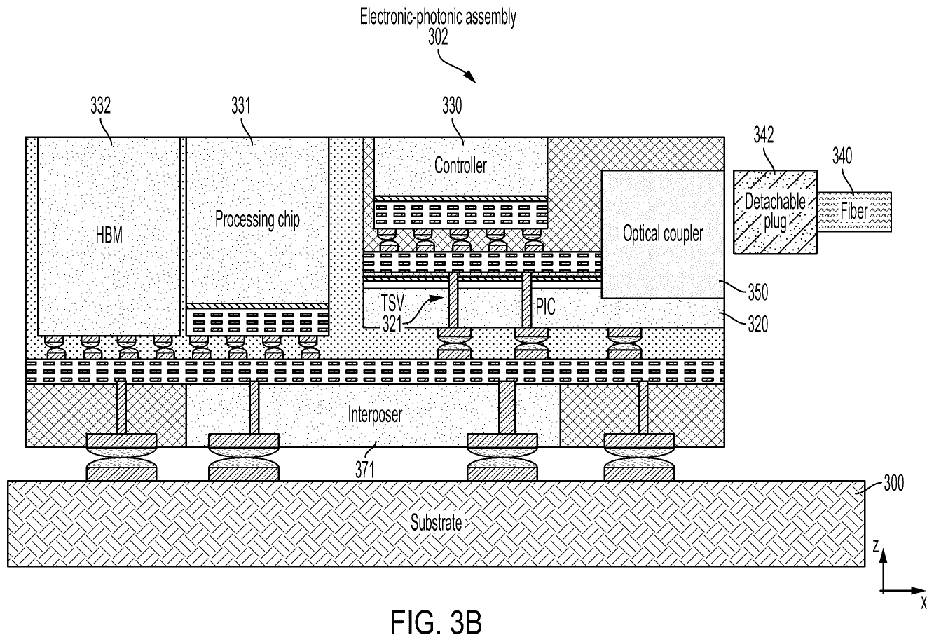

Referring to FIG. 3A, a package includes an electronic-photonic assembly having a side optical coupler and a detachable plug 342 holding an optical fiber 340. A substrate 300 is positioned at the bottom of the package. The substrate 300 provides structural support and signal routing capabilities. The substrate 300 may form part of an interposer configured to route signals generated inside the device to external devices and vice versa.

PIC 320 may have characteristics similar to the characteristics of PIC 120 of FIG. 1A. For example, PIC 320 includes a waveguide 328 that guides light within a waveguide plane. The waveguide 328 defines the waveguide plane that is parallel to the xy plane of FIG. 3A. In some embodiments, the PIC 320 may be made of silicon and the waveguide 328 may be made of silicon or silicon nitride. The PIC 320 may be active in nature and may include modulators, photodetectors, and/or optical switches. A plurality of through-silicon vias (TSV) 321 are patterned within the PIC 320. The TSVs 321 provide electrical communication between the electronic circuitry of the PIC 320 and the substrate 300.

The PIC 320 defines a recess 329 that accommodates the optical coupler 350. The optical coupler 350 is configured to receive light from the waveguide 328 and direct it in a direction angled relative to the waveguide plane. In some embodiments, the optical coupler 350 may cause light to be emitted outside the waveguide plane in a vertical direction or at a slight angle relative to the z-axis of less than 20 degrees. A PIC edge 326 is visible at the periphery of the PIC 320. A sidewall 347 is formed within the structure of the PIC 320. The sidewall 347 may be positioned proximate to an end of the waveguide 328. Recess 329 separates edge 326 from sidewall 347 in the lateral direction, along the x-axis. By positioning the recess 329 between the sidewall 347 and the edge 326, the PIC 320 emits light through the sidewall 347 rather than through the edge 326. The edge 326 may exhibit surface roughness resulting from singulation processes, which can cause scattering, unwanted reflections, or mode distortion. The recess 329 enables light to exit the PIC 320 through the sidewall 347, thereby minimizing interaction between the optical signal and the rough edge surface and preserving signal integrity.

A controller 330 is attached to the PIC 320, forming part of the electronic-photonic assembly. The controller 330 includes electronic circuitry configured to interface with active photonic circuitry within the PIC 320. As further shown in FIG. 3A, an underfill 322 fills the space between the PIC 320 and the controller 330. The underfill 322 protects the bumps, pads, or other types of electrical features connecting the top surface of the PIC 320 to the bottom surface of the controller 330. An encapsulant 324 at least partially surrounds the controller 330. The encapsulant 324 provides mechanical stability and warpage control to the assembly. In some embodiments, the encapsulant 324 may laterally surround the controller 330 on two, three, or four sides.

The optical coupler 350 includes a reflective portion 351 positioned near the recess 329. The reflective portion 351 is configured to reflect light in a first direction that is angled relative to the waveguide plane. A second reflective portion 352 is positioned at an upper region of the optical coupler 350. The reflective portion 352 is configured to redirect light toward an optical assembly. In some embodiments, the reflective portion 351 and the reflective portion 352 may each be angled by approximately 45 degrees relative to the waveguide plane. The reflective portion 351 and the reflective portion 352 may each be implemented as a conductive surface having a large reflection coefficient, or may be implemented to operate by total internal reflection. Collectively, the reflective portion 351 and the reflective portion 352 form an optical conduit configured to steer light exiting the PIC 320 towards the input plane of the fiber 340 without being absorbed by the encapsulant 324.

The optical assembly includes the detachable plug 342 and the fiber 340 attached to the detachable plug 342. The detachable plug 342 includes a lens 341 configured to focus light received from the optical coupler 350 onto the input plane of the fiber 340. The fiber 340 is oriented along a plane substantially parallel to the waveguide plane in the region where the fiber 340 is attached to the detachable plug 342. A heat spreader 360 is attached to the top surface of the controller 330. The heat spreader 360 facilitates distribution of heat generated within the package to the external environment. The heat spreader 360 also provides protection for the underlying components.

Referring to FIG. 3B, a package includes an electronic-photonic assembly 302 disposed on an interposer 371. Electronic-photonic assembly 302 may be implemented using the ASIC-PIC stack described with reference to FIG. 3A. The interposer 371 is configured as a partial interposer that serves as a bridge between selected components of the package rather than interconnecting all packaged chips and assemblies together. A substrate 300 is positioned at the bottom of the package. The substrate 300 may be a printed circuit board (PCB) or an organic substrate configured to route signals generated inside the device to external devices and vice versa. The interposer 371 is attached to the substrate 300. The package includes a processing chip 331 and a high-bandwidth memory (HBM) 332 disposed on the interposer 371. Interposer 371 places electronic-photonic assembly 302 in electrical communication with processing chip 331, but not with HBM 332.

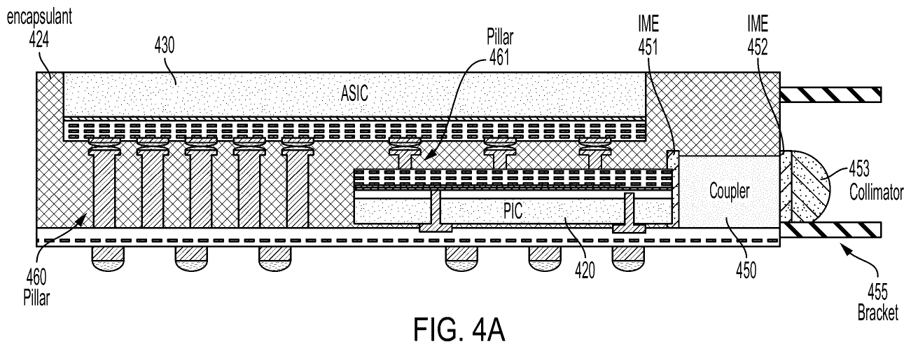

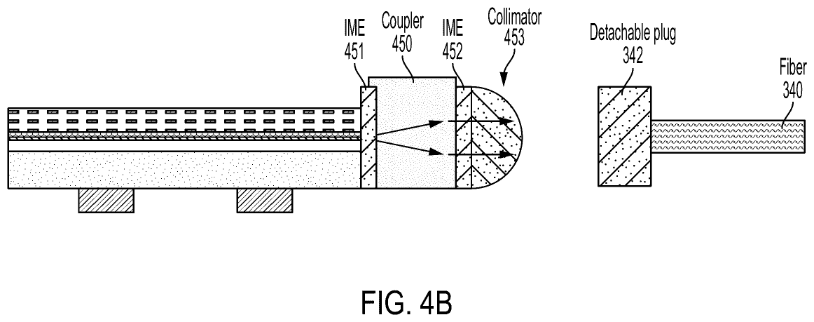

Referring to FIG. 4A, a photonic device includes an electronic-photonic assembly with an optical coupler configuration where an ASIC 430 extends partially beyond a photonic integrated circuit (PIC) 420. The ASIC 430 is attached to the PIC 420. A portion of the ASIC 430 extends beyond an edge of the PIC 420. This arrangement differs from arrangements in which an entire bottom surface of an ASIC is disposed on top of a PIC. The ASIC 430 may include input/output (I/O) circuitry, control circuitry, processing circuitry, and/or memory circuitry. In some embodiments, the ASIC 430 may include electronic components configured to interface with active photonic circuitry within the PIC 420.

An encapsulant 424 at least partially surrounds the electronic-photonic assembly. The device includes two sets of pillars for electrical connectivity. A first set of pillars 461 connects a bottom surface of the ASIC 430 to the PIC 420. A second set of pillars 460 connects the bottom surface of the ASIC 430 to an underlying support structure. The underlying support structure may a partial interposer. Both the first set of pillars 461 and the second set of pillars 460 traverse the encapsulant 424 in a vertical direction. This pillar arrangement accommodates the configuration in which the portion of the ASIC 430 extends beyond the edge of the PIC 420.

As further shown in FIG. 4B, a coupler 450 is positioned adjacent to the PIC 420 to facilitate light coupling between the PIC 420 and an external fiber. The coupler 450 forms an optical conduit through the surrounding encapsulant 424. An index-matching epoxy (IME) 451 is disposed between the edge of the PIC 420 and the coupler 450. The IME 451 promotes optical coupling between the PIC 420 and the coupler 450 while minimizing back-reflections at the interface. A collimator 453 is attached to a side of the coupler 450. The collimator 453 is configured to perform optical collimation of light passing through the coupler 450. An IME 452 is disposed between the coupler 450 and the collimator 453. The IME 452 minimizes back-reflections at the interface between the coupler 450 and the collimator 453. The collimator 453 may define a convex surface with curvature designed to collimate the beam emitted by the PIC 420 and passing through the coupler 450. Use of the collimator 453 makes the system more robust against misalignments between a detachable plug and the optical device.

Referring back to FIG. 4A, a set of brackets 455 is positioned adjacent to the collimator 453. The set of brackets 455 facilitates attachment of a detachable plug to the package. The set of brackets 455 enables straightforward connection and removal of optical fibers, allowing optical fibers to be readily removed and replaced without requiring disposal or replacement of the entire device.

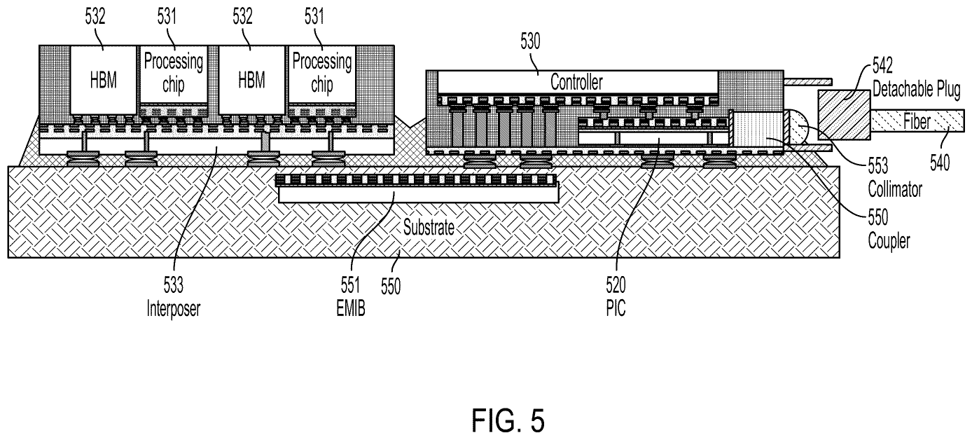

The preceding embodiments have described CoWoS-L as an example of a partial interposer architecture. However, other types of partial interposer architectures are possible. Another example of a partial interposer architecture includes embedded multi-die interconnect bridge (EMIB) configurations. An EMIB may be embedded within a substrate and may provide localized high-density interconnections between adjacent dies. The EMIB approach may allow for selective bridging between components without requiring a full interposer spanning the entire package area. EMIB configurations may be used in connection with either top optical couplers or side optical couplers of the types described herein. A possible implementation using a side coupler with an EMIB configuration is shown in FIG. 5.

As shown in FIG. 5, a package includes an electronic-photonic assembly disposed on substrate with an embedded multi-die interconnect bridge (EMIB) 551 configuration. The EMIB 551 configuration represents another example of a partial interposer architecture in which localized high-density interconnections are provided between adjacent dies without requiring a full interposer spanning the entire package area.

A controller 530 is attached to the PIC 520. The controller 530 includes electronic components configured to interface with active photonic circuitry within the PIC 520. An interposer 533 supports processing chips 531 and high-bandwidth memory (HBM) 532 components. The EMIB 551 is configured to place the electronic-photonic assembly in electrical communication with the processing chips 531 and the HBM 532. The EMIB 551 serves as a localized high-density interconnect bridge that is embedded within the interposer 533. The EMIB 551 provides selective bridging between the electronic-photonic assembly and adjacent components without requiring a full interposer spanning the entire package area.

As further shown in FIG. 5, an optical assembly including a detachable plug 542 and a fiber 540 attached to the detachable plug 542 is positioned to receive light from the PIC 520. A coupler 550 is disposed between the PIC 520 and the detachable plug 542. The coupler 550 is configured to couple light received from the PIC 520 to the fiber 540. The coupler 550 forms an optical conduit that directs light between the PIC 520 and the optical assembly. A collimator 553 is positioned between the coupler 550 and the detachable plug 542. The collimator 553 is configured to collimate light passing through the optical path between the PIC 520 and the fiber 540.

### IV. Additional Remarks

While the implementations illustrated herein use reflective portions 151 (FIGS. 1A), 251 (FIG. 2B), and 351 (FIG. 3A), some embodiments of the PICs may include one or more grating couplers to couple light into and out from the waveguides of the PIC. A grating coupler may be optically coupled to a waveguide and configured to emit light received from the waveguide outside the waveguide plane, whether in the vertical direction or at a slight angle relative to the z-axis. In embodiments using grating coupler, the reflective portion (such as reflective portion 151) may be omitted since the grating coupler directly emits light outside the waveguide plane. In top coupling configurations, such as those illustrated in FIG. 1A, the optical coupler may be configured to collimate light emitted through the grating coupler and direct the collimated light outside the top surface of the PIC toward the fiber. In side coupling configurations, such as the one illustrated in FIG. 3A, the optical coupler may include a reflective portion configured to steer light emitted from the grating coupler toward the side of the package and into the fiber. In some embodiments, the optical coupler may include both a collimating portion and a reflective portion to collimate and redirect light emitted by the grating coupler toward the plurality of optical fibers.

In some embodiments, the plurality of optical fibers described herein may include various fiber types depending on the application requirements. The fibers may be single-mode fiber, multimode fiber, polarization-maintaining fiber, or hollow-core fiber. Single-mode fibers may be used in applications requiring long-distance transmission with minimal signal degradation. Multimode fibers may be suitable for shorter-distance, high-bandwidth applications. Polarization-maintaining fibers may be employed in applications where preserving the polarization state of light is desired. Hollow-core fibers may offer advantages such as reduced latency and lower nonlinear effects for certain applications.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

As used herein, terms such as “above,” “below,” “over,” “under,” “adjacent,” “upper,” “top,” “lower,” “bottom,” “vertical,” “horizontal,” “lateral,” and similar positional or directional descriptors are used solely to describe the relative arrangement and orientation of features as illustrated in the drawings and are not intended to be limiting. Such terms do not require any particular orientation of the device in use, manufacture, or operation, and the described features may be oriented in any direction without departing from the scope of the present disclosure. Moreover, these terms are not intended to imply any absolute position, gravitational reference, or fixed spatial relationship, and components described as being positioned using positional or directional descriptors may be arranged in different relative positions, including inverted, rotated, or otherwise reoriented configurations, while still performing the same function in substantially the same way to achieve substantially the same result.

What is claimed is:

1. A photonic device, comprising:
a package comprising a partial interposer and an electronic-photonic assembly disposed on the partial interposer, the electronic-photonic assembly comprising:
a photonic integrated circuit (PIC) having a first side and a second side opposite the first side, wherein the first side of the PIC is attached to the partial interposer, and wherein the PIC comprises a waveguide defining a waveguide plane;
an electronic integrated circuit (EIC) attached to the second side of the PIC; and
an encapsulant at least partially surrounding the EIC;
an optical coupler attached to the PIC, wherein the optical coupler is configured to collimate, in a first direction that is angled relative to the waveguide plane, light emitted by the PIC upon being guided by the waveguide; and
an optical assembly comprising a detachable plug and a fiber attached to the detachable plug, wherein the optical assembly is positioned to receive the collimated light from the optical coupler.

2. The photonic device of claim 1, wherein the package is configured as a chip-on-wafer-on-substrate (CoWoS) package in which the partial interposer serves as a bridge between the electronic-photonic assembly and at least one other component of the package.

3. The photonic device of claim 1, wherein the optical assembly is disposed on a top surface of the encapsulant.

4. The photonic device of claim 1, wherein the optical coupler comprises:
a reflective portion configured to reflect the light emitted by the PIC in the first direction; and
a convex portion configured to perform the collimation.

5. The photonic device of claim 4, wherein the PIC defines a recess near an end of the waveguide, and wherein the reflective portion extends into the recess.

6. The photonic device of claim 5, further comprising an index-matching epoxy disposed in the recess.

7. The photonic device of claim 1, wherein the optical coupler extends through the encapsulant.

8. The photonic device of claim 1, wherein the detachable plug comprises a fiber array unit (FAU) configured to hold the fiber with a predefined pitch.

9. The photonic device of claim 1, further comprising a second EIC and a third EIC disposed on the partial interposer, wherein the partial interposer places the electronic-photonic assembly in electrical communication with the second EIC but not the third EIC.

10. The photonic device of claim 9, wherein the second EIC comprises a processing chip, and the third EIC comprises a high-bandwidth memory.

11. A photonic device, comprising:
a package comprising a partial interposer and an electronic-photonic assembly disposed on the partial interposer, the electronic-photonic assembly comprising:
a photonic integrated circuit (PIC) comprising a waveguide extending near a sidewall of the PIC;
an electronic integrated circuit (EIC) attached to the PIC; and
an encapsulant at least partially encapsulating the EIC;
an optical assembly comprising a detachable plug and a fiber attached to the detachable plug; and
an optical coupler between the sidewall of the PIC and the optical assembly, wherein the optical coupler is configured to couple light received from the waveguide to the fiber.

12. The photonic device of claim 11, wherein the package is configured as a chip-on-wafer-on-substrate (CoWoS) package in which the partial interposer serves as a bridge between the electronic-photonic assembly and at least one other component of the package.

13. The photonic device of claim 11, wherein the optical coupler comprises:
a first reflective portion configured to reflect the light received from the waveguide in a first direction that is angled relative to a plane defined by the waveguide; and
a second reflective portion configured to reflect the light reflected by the first reflective portion in a second direction that is parallel to the plane defined by the waveguide.

14. The photonic device of claim 11, wherein the optical coupler is made of silicon.

15. The photonic device of claim 11, wherein the PIC defines a recess near an edge of the PIC, and wherein the optical coupler is disposed in the recess.

16. The photonic device of claim 11, wherein the optical coupler extends through the encapsulant.

17. The photonic device of claim 11, wherein the optical coupler comprises a collimator configured to collimate the light received from the waveguide.

18. The photonic device of claim 17, wherein the collimator comprises a convex surface.

19. The photonic device of claim 11, further comprising a second EIC and a third EIC disposed on the partial interposer, wherein the partial interposer places the electronic-photonic assembly in electrical communication with the second EIC but not third EICs.

20. The photonic device of claim 19, wherein the second EIC comprises a processing chip, and the third EIC comprises a high-bandwidth memory.
